(19) United States
(12) Patent Application Publication
(10) Pub. No.: US 2012/0052464 A1
(43) Pub. Date: Mar. 1, 2012

(54) ANTI-ROTATIONAL ABUTMENT SCREW CAP AND A METHOD FOR USING THE SAME

(76) Inventor: David Michael OCHENRIDER, Albuquerque, NM (US)

(21) Appl. No.: 13/078,960

(22) Filed: Apr. 2, 2011

Related U.S. Application Data
(60) Provisional application No. 61/379,290, filed on Sep. 1, 2010.

(51) Int. Cl. A61C 8/00

(52) U.S. Cl. 433/174

(57) ABSTRACT

An anti-rotational abutment screw cap includes a generally cylindrical-shaped body, the cylindrical-shaped body having a socket-end portion and an insert-end portion; a blind recess socket located on an end of the socket-end portion for receiving a torque wrench driver, the blind recess socket having an interior configuration; a retentive edge formed above and around the blind recess socket for engaging prosthetic cement; an insert key protruding from an end of the insert-end portion for engaging a head opening of an abutment screw, the insert key having an exterior configuration which generally mating with the interior configuration of the blind recess socket.

### CROSS-REFERENCE TO RELATED APPLICATION

The present application claims the benefit under 35 U.S.C. §119(e) of U.S. Provisional Application No. 61/379,290, filed Sep. 1, 2010, which is incorporated herein by reference.

### BACKGROUND OF THE INVENTION

Current dental implant systems generally include three components, an implant body, an abutment, and an abutment screw. A prosthesis, such as a crown, may be supported by said implant system. The abutment may be attached to the implant body with an abutment screw. One problem of dental implant use may be the problem of loosening of the abutment screw over time under occlusal loads. Accessing the abutment screw, and removing or tightening the abutment/prosthesis complex presents significant challenges to the dentist.

The current dental implant protocol recommends “protecting” the abutment screw head from prosthetic cement with materials such as a cotton pellet or temporary filling material. The recommended “protection” provides no anti-rotational support. Furthermore, a torque wrench driver must engage the abutment screw head directly when removal of the prosthesis is required. The torque wrench driver may place significant stress on the complex, leading to fracture of the prosthesis.

Some presently available designs provide anti-rotation abutment screw caps. These abutment screw caps, however, require modifications to the generally used abutments and to standard abutments screws, or have complicated designs with moving parts.

Accordingly, there is a need for an improved and simplified screw cap with anti-rotational properties.

### SUMMARY OF THE INVENTION

In one aspect the present invention, an anti-rotational abutment screw cap, comprises a generally cylindrical-shaped body, the cylindrical-shaped body having a socket-end portion and an insert-end portion; a blind recess socket located on an end of socket-end portion for receiving a torque wrench driver, the blind recess socket having an interior configuration; a retentive edge formed above and around the blind recess socket for engaging prosthetic cement; an insert key protruding from an end of the insert-end portion for engaging a head opening of an abutment screw, the insert key having an exterior configuration which generally mating with the interior configuration of the blind recess socket.

Another aspect of the present invention, an integrated anti-rotational abutment screw/screw cap, comprises a generally cylindrical-shaped body, the cylindrical-shaped body having a socket-end portion and an abutment screw-end portion; a blind recess socket located on an end of socket-end portion for receiving a torque wrench driver, the blind recess socket having an interior configuration; a retentive edge formed above and around the blind recess socket for engaging prosthetic cement; a shoulder formed at an end of the abutment screw-end portion for engaging an abutment; and a threaded stem protruding from the shoulder for penetrating an implant body.

Still another aspect, a method for securing a prosthesis over an abutment, comprises fitting a torque wrench driver in a socket of an ARASC; guiding the ARASC in an abutment chamber and seating the ARASC in the head opening of an abutment screw; and securing a prosthesis in place over an abutment.

These and other features, aspects and advantages of the present invention may be become better understood with reference to the following drawings, description and claims.

### BRIEF DESCRIPTION OF THE DRAWINGS

FIG. 1 is a cross-sectional view of an anti-rotational abutment screw cap (ARASC)in use according to an embodiment of the present invention;

FIG. 2 is a top perspective view of the ARASC of FIG. 1;

FIG. 3 is a bottom perspective view of the ARASC of FIG. 1;

FIG. 4 is a cross-sectional view of an ARASC in use according to another embodiment of the present invention;

FIG. 5 is a flowchart of a method for using the ARASC for securing the prosthesis over the abutment according to an exemplary embodiment of the present invention; and

FIG. 6 is a flowchart of a method for using the ARASC for removing an abutment/prosthesis complex according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides an anti-rotational abutment screw cap (ARASC) for use in dental implants.

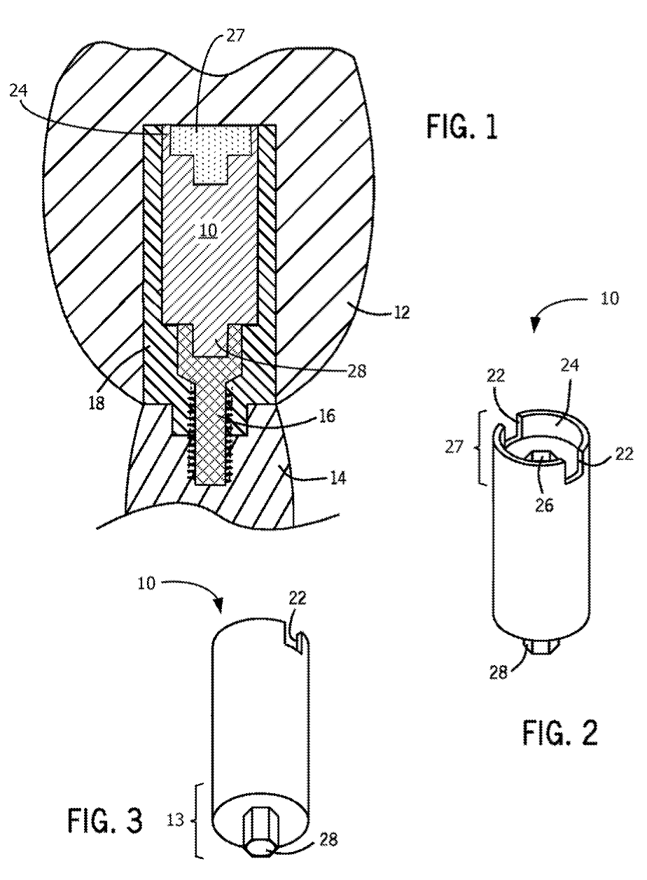

Referring now to FIGS. 1-3, different views of the ARASC 10 are shown according to an exemplary embodiment of the present invention. The ARASC 10 may be a single piece device. The ARASC 10 may have a cylindrical shaped body, and its size may depend on the size of an abutment 18. The ARASC 10 may be formed with two functional end portions. A socket-end portion 27 may be formed to engage the prosthetic cement adhered to prosthesis 12 and to receive a torque wrench driver. An insert-end portion 13 is adapted to engage the abutment screw 16 head.

The socket-end portion 27 may include a blind recess socket 26. A retentive edge 24 may be formed above and around the socket 26. The socket 26 may have an interior configuration with a polygonal cross section. The retentive edge 24 may include at least two retentive notches 22, however other retentive features, for example, saw-tooth, or a flat dimpled surface may be used instead of the notches 22. The retentive edge 24, along with the retentive notches 22, may lock the ARASC 10 into position with the application of prosthetic cement, thereby preventing the abutment screw 16 from loosening, i.e., anti-rotating.

The insert portion may include an insert key 28. The insert key 28 may protrude from the cylindrical body of the ARASC 10. The insert key 28 may have an exterior configuration which may generally be the same configuration as the interior configuration of the socket 26. A cross-section of the insert key 28 may be a hexagonal shape, however other polygonal shapes for example, square or star may also be utilized.

The socket 26 and insert key 28 may have interior and exterior configurations that match the configuration of the head opening of the abutment screw 16. The ARASC 10 may work with most geometrically shaped screw heads and their corresponding torque wrench drivers.

The socket-end portion 27 may also serve as a visible guide. In order to do so, the socket-end portion 27 may be brightly colored. The brightly colored socket-end portion 27 may mark the abutment chamber, helping to access the abutment screw 16 following cementation of the prosthesis 12, minimizing the damage to the prosthesis 12 and abutment 18.

The ARASC 10 may be made of metal to withstand the force needed to remove a well secured abutment screw 16. It may, however, be made of any sufficiently strong material, for example, plastic, composite or reinforced resin. The dimensions of the ARASC 10 may be determined by both the design of the abutment screw 16 and by the size of the abutment 18. Currently the abutment screws 16 come in one shape/size per implant system, consequently the ARASC 10 may be made with one mating insert key design and with different body lengths to adapt to different sizes of the abutment 18.

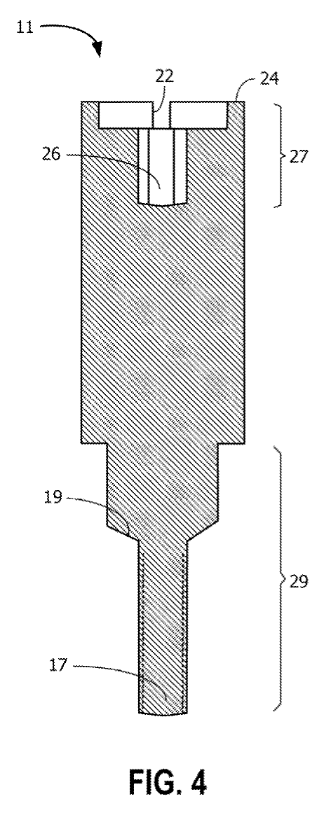

Referring now to FIG. 4, a cross-sectional view of an integrated anti-rotational abutment screw/screw cap (ARASSC) 11 is shown according to another embodiment of the present invention. The ARASSC 11 may be made by combining both the structures and the functions of the ARASC 10 and the. abutment screw 16 into a single solid body. The ARASSC 11 may have a socket-end portion 27 and an abutment screw portion 29. The socket-end portion 27 may be identical to the socket-end portion of the ARASC 10. The properties of the abutment screw portion 29 may generally be the same as the properties of the abutment screw 16. The abutment screw portion 29 may include shoulder 19 and a threaded stem 17.

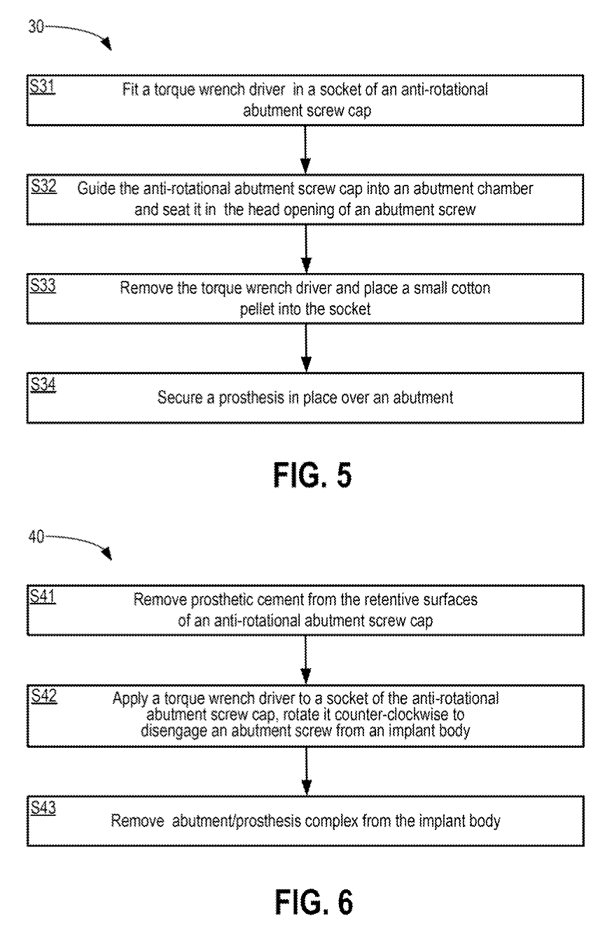

Referring now to FIG. 5, a flow chart illustrating a method 30 for using the ARASC 10 for securing the prosthesis 12 over the abutment 18 is shown according to another exemplary embodiment of the present invention.

The method 30 may start in step S31 once the abutment 18 is properly attached to the implant body 14. In step S31, the torque wrench driver may be fitted in the socket 26. In steps S32, the ARASC 10 may be guided into the abutment chamber and may be seated to completely engage the head opening of the abutment screw 16. In step S33, the torque wrench driver may be removed and a small cotton pellet 27 may be placed into the socket 26, leaving retentive surfaces exposed. The cotton pellet 27 may protect the socket 26 from being filled with prosthetic cement. In steps S34, the prosthesis 12 may be secured in place over the abutment/ARASC complex by prosthetic cement. The prosthetic cement may engage the retentive notches 22.

Referring now to FIG. 6, a flow chart illustrating a method 40 for using the ARASC 10 for removal of the abutment/prosthesis complex is shown according. to yet another exemplary embodiment of the present invention. When a need arises to access and to remove the abutment/prosthesis complex, the brightly colored ARASC 10 may serve as a guide to show where to enter the abutment channel with minimal damage to the abutment 18.

The method 40 may start in step S41. In step S41, the prosthetic cement may be removed from the retentive surfaces of the ARASC 10. The cotton pellet 27 may then be removed from the socket 26. In steps S42, the torque wrench driver may be applied to the socket and may be rotated counter-clockwise to disengage the abutment screw 16 from the implant body 14. In step S43, the abutment prosthesis complex may be removed.

It should be understood, of course, that the foregoing relates to exemplary embodiments of the invention and that modifications may be made without departing from the spirit and scope of the invention as set forth in the following claims

What is claimed is:

1. An anti-rotational abutment screw cap (ARASC), comprising:
a cylindrical-shaped body, the cylindrical-shaped body having a socket-end portion and an insert-end portion;
a blind recess socket located on an end of the socket-end portion for receiving a torque wrench driver, the blind recess socket having an interior configuration;
a retentive edge formed above and around the blind recess socket for engaging prosthetic cement;
an insert key protruding from an end of the insert-end portion for engaging a head opening of an abutment screw, the insert key having an exterior configuration generally mating with the interior configuration of the blind recess socket.

2. The ARASC of claim 1, wherein the interior configuration of the blind recess socket has an interior configuration with a polygonal cross section.

3. The ARASC of claim 1, wherein the interior configuration of the blind recess socket has an interior configuration with a hexagonal cross section.

4. The ARASC of claim 1, wherein the retentive edge includes at least two retentive notches.

5. The ARASC of claim 1, cylindrical-shaped body is made of one of metal, plastic, composite and reinforced resin.

6. The ARASC of claim 1, wherein the socket-end portion of the ARASC is brightly colored.

7. An integrated anti-rotational abutment screw/screw cap, comprising:
A generally cylindrical-shaped body, the cylindrical-shaped body having a socket-end portion and an abutment screw-end portion;
a blind recess socket located on an end of the socket-end portion for receiving a torque wrench driver, the blind recess socket having an interior configuration;
a retentive edge formed above and around the blind recess socket for engaging prosthetic cement;
a shoulder formed at an end of the abutment screw-end portion for engaging an abutment; and
a threaded stem protruding from the shoulder for penetrating an implant body.

8. A method for securing a prosthesis over an abutment, comprising:
fitting a torque wrench driver in a socket of an ARASC;
guiding the ARASC into an abutment chamber and seating the ARASC in the head opening of an abutment screw; and
securing a prosthesis in place over an abutment.
